(19) United States
(12) Patent Application Publication
(10) Pub. No.: US 2026/0139548 A1
(43) Pub. Date: May 21, 2026

(54) CURTAIN AND CARRYING CORD WINDING AND UNWINDING DEVICE THEREOF

(71) Applicant: Xiangyi WEN, Ji’an City (CN)

(72) Inventor: Xiangyi WEN, Ji’an City (CN)

(21) Appl. No.: 19/020,619

(22) Filed: Jan. 14, 2025

(30) Foreign Application Priority Data
Nov. 20, 2024 (CN) 202411665590.X

(51) Int. Cl. E06B 9/322

(52) U.S. Cl. CPC E06B 9/322; E06B 2009/3222; E06B 2009/3225

(57) ABSTRACT

A carrying cord winding and unwinding device includes a base defining a cord outlet, a reel rotatably mounted to the base and defining two wind slots, a cord guide mechanism, and two carrying cords. Corresponding ends of the carrying cords are wound in a same direction in the wind slots, while the other ends are led out from the wind slots and extended out from the cord outlet. The cord guide mechanism includes a synchronous guide component which including a core shaft, and a slide sleeve axially slidably fitted about the core shaft. An outer side of the slide sleeve defines two annular guide slots. A bottom width of the annular guide slots is adapted to a diameter of the carrying cords, and a center distance of the annular guide slots is the same as a distance between leading out positions of the carrying cords.

### FIELD OF THE PRESENT INVENTION

The present invention relates to the technical field of curtain accessories and, more particularly to a curtain and a carrying cord winding and unwinding device of the curtain.

### BACKGROUND OF THE PRESENT INVENTION

Currently, a curtain usually includes an upper beam, a carrying cord winding and unwinding device assembled on the upper beam, and a curtain body set below the upper beam. The carrying cord winding and unwinding device includes a base, a cord winding reel rotatably mounted to the base, a carrying cord with a top end being wound on the cord winding reel and a bottom end being connected to the curtain body, and a power mechanism for driving the cord winding reel to rotate. Usually, the curtain body is symmetrically connected to at least two carrying cords in its width direction to support the curtain body, ensuring that the curtain body is balanced in terms of force and lifting, without tilting.

For this reason, a cord winding reel of an existed carrying cord winding and unwinding device usually defines at least two wind slots arranged side by side along an axial direction on an outer side of the cord winding reel. Each of the wind slots is correspondingly wound with a carrying cord. The carrying cord led out from each wind slot of the cord winding reel extends down from a corresponding position of an upper beam and is symmetrically connected to a curtain body after extending about a corresponding guide rod.

However, in specific implementation, when the carrying cord is wound up by the winding reel, the winding positions of each carrying cord in the corresponding wind slot move one by one in the axial direction of the winding reel, and the winding contact point of the carrying cord on the guide rod also changes in the axial direction. Due to the lack of a structure for guiding the carrying cord to move axially on the guide rod, the axial movement of each carrying cord on the guide rod is difficult to maintain synchronization, which easily leads to inconsistent winding lengths of each carrying cord on the winding reel. Correspondingly, when unwinding the carrying cord from the winding reel, the length of each carrying cord being unwound may also be inconsistent. Therefore, it will also lead to inconsistent lengths of the unwound carrying cords when unwinding them from the winding reels. The device cannot guarantee the synchronization of the winding and unwinding of each carrying cord, which can easily cause the curtain body of the curtain to tilt with one end higher and the other lower during lifting.

### SUMMARY OF THE INVENTION

### Technical Problem

Therefore, the technical problem to be solved by the embodiments of the present invention is to provide a carrying cord winding and unwinding device of a curtain, which can ensure synchronous lifting and lowering of both ends of a curtain body.

Another technical problem to be solved by the embodiments of the present invention is to provide a curtain, which can ensure synchronous lifting and lowering of both ends of a curtain body.

### Solutions to the Problem

To solve the above-mentioned technical problems, an embodiment of the present invention provides the following solutions. A carrying cord winding and unwinding device of a curtain includes a base defining a cord outlet in a predetermined position, a reel rotatably mounted to the base and defining at least two wind slots arranged side by side along an axial direction in an outer surface of the reel, a cord guide mechanism set on the base and arranged between the reel and the cord outlet, and at least two carrying cords corresponding one-to-one with the at least two wind slots. Corresponding ends of the at least two carrying cords are wound in a same direction in the at least two wind slots, respectively, while the other ends are respectively led out from the at least two wind slots and extended out from the cord outlet under the guidance of the cord guide mechanism. The cord guide mechanism includes at least one synchronous guide component, and each of the at least one synchronous guide component includes a core shaft arranged parallel to the reel and located on a side of the reel, and a slide sleeve axially slidably fitted about the core shaft. An outer side of the slide sleeve defines at least two annular guide slots that correspond one-to-one with the at least two wind slots and are arranged side by side in an axial direction of the slide sleeve. A bottom width of the at least two annular guide slots is adapted to a diameter of the at least two carrying cords, and a center distance of any two adjacent annular guide slots is the same as a distance between leading out positions of the carrying cords in any two adjacent wind slots.

Furthermore, the at least one synchronous guide component includes at least two synchronous guide components arranged in parallel at corresponding corners of the base, the at least two carrying cords led out by the reel sequentially extend about the at least two synchronous guide components and then extend in a direction of the cord outlet; the reel is arranged at one end of the base and is located on an inner side of movement paths of the at least two carrying cords between the at least two synchronous guide components.

Furthermore, the cord guide mechanism further includes a plurality of guide rods arranged between the at least two synchronous guide components and the cord outlet and arranged in sequence along the movement paths of the at least two carrying cords, and each of the plurality of guide rods has a smooth outer surface; the at least two carrying cords extend from the at least two synchronous guide components, extend about the outer surfaces of the plurality of guide rods, and then extend out through the cord outlet.

Furthermore, a cross-section of each of the at least two annular guide slots is V-shaped or U-shaped.

Furthermore, the cord outlet is located at one end of the base away from the reel, one of the plurality of guide rods is provided on an inner side of the cord outlet, and a partition rod is assembled inside the cord outlet; the partition rod divides the cord outlet into a plurality of channels in the axial direction of the plurality of guide rods, which are the same number as the number of the at least two carrying cords; the at least two carrying cords extend out from the plurality of channels in a one-to-one correspondence.

Furthermore, each of opposite ends of the base defines one said cord outlet.

Furthermore, the base includes a bottom shell and a shell cover that are interlocked to form an installation space for accommodating the reel and the cord guide mechanism, the cord outlet is defined in the bottom shell.

Furthermore, the carrying cord winding and unwinding device further includes a planar spiral spring mechanism assembled in the installation space for driving the reel to rotate to wind the at least two carrying cords, an output shaft of the planar spiral spring mechanism is coaxially provided with a driving gear, and the reel is coaxially provided with a driven gear, which meshes with the driving gear.

Furthermore, each of the at least two wind slots is provided with a fixing hole for fixing the end of a corresponding carrying cord, the fixing holes located in the at least two wind slots are arranged in a straight line at equal intervals in the axial direction of the reel, and a hole spacing between any two adjacent fixing holes is the same as the center distance between any two adjacent annular guide slots.

On the other hand, to solve the above-mentioned technical problems, an embodiment of the present invention provides the following solutions. A curtain includes an upper beam, a carrying cord winding and unwinding device assembled on the upper beam and the ladder winding and unwinding device is the above-mentioned carrying cord winding and unwinding device, and a curtain body arranged below the upper beam and connected to the at least two carrying cords, which rises correspondingly under the driving of the carrying cord winding and unwinding device.

### Beneficial Effects of the Invention

By adopting the above technical solution, embodiments of the present invention have at least the following beneficial effects. The embodiment of the present invention adds a synchronous guide component on the side of the reel, and the synchronous guide component includes a core shaft and a slide sleeve slidably fitted about the core shaft. The outer side of the slide sleeve defines at least two annular guide slots that correspond one-to-one with the at least two wind slots and are distributed side by side in the axial direction for the at least two carrying cords to be wound correspondingly. The bottom width of the at least two annular guide slots is designed to match the diameter of the at least two carrying cords, which can effectively prevent the carrying cords from sliding axially in the corresponding annular guide slots and only drive the slide sleeve to slide axially. During the process of winding or unwinding the carrying cords, the carrying cords are wound in the wind slots along the axial direction of the reel, and drive the slide sleeve to slide synchronously axially on the core shaft. Moreover, By designing the center distance between any two adjacent annular guide slots to be the same as the spacing between the leading out positions of the carrying cords in any two adjacent wind slots, the lengths of the carrying cords can always be kept consistent, while ensuring that the curtain body connected to the other ends of the carrying cords can always be balanced and lifted without tilting.

### BRIEF DESCRIPTION OF THE DRAWINGS

FIG. 1 is an exploded, isometric view of an embodiment of a carrying cord winding and unwinding device of a curtain.

FIG. 2 is another exploded, isometric view of the carrying cord winding and unwinding device, but viewed from another perspective.

FIG. 3 is an assembled, isometric view of the carrying cord winding and unwinding device of FIG. 2.

FIG. 4 is a cross-sectional view of the carrying cord winding and unwinding device, taken along a plane of a central axis of a core shaft and a reel.

FIG. 5 is another cross-sectional view of the carrying cord winding and unwinding device, taken along a central axial plane of a shell in a length direction.

FIG. 6 is still another cross-sectional view of the carrying cord winding and unwinding device, taken along a central axial plane of a partition rod in a length direction.

FIG. 7 is an exploded, isometric view of the curtain.

FIG. 8 is an assembled, isometric view of the curtain.

### DETAILED DESCRIPTION OF THE PRESENT INVENTION

The present application will be further described in detail below with reference to the accompanying drawings and embodiments. It should be understood that the following illustrative embodiments and illustrations are only used to explain the present invention and are not intended to limit the present invention, and that the embodiments of the present invention and the features of the embodiments can be combined with each other without conflict.

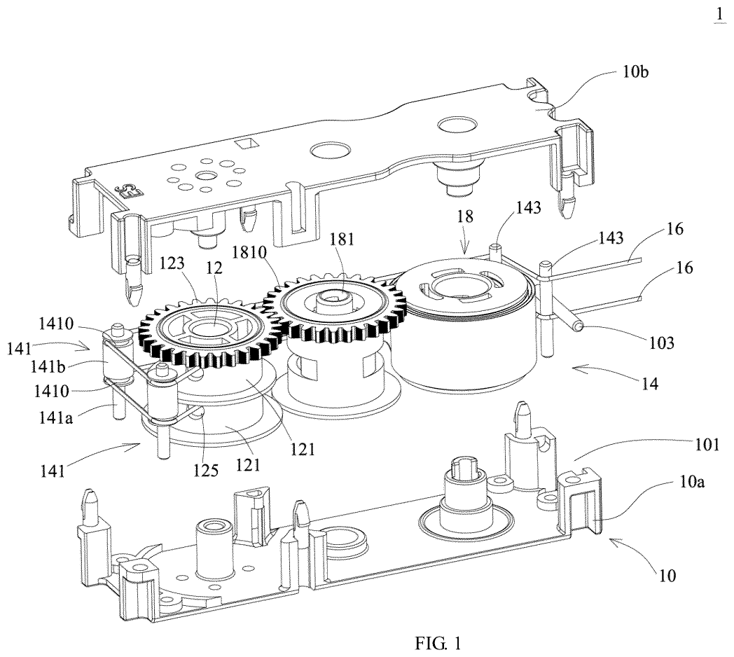

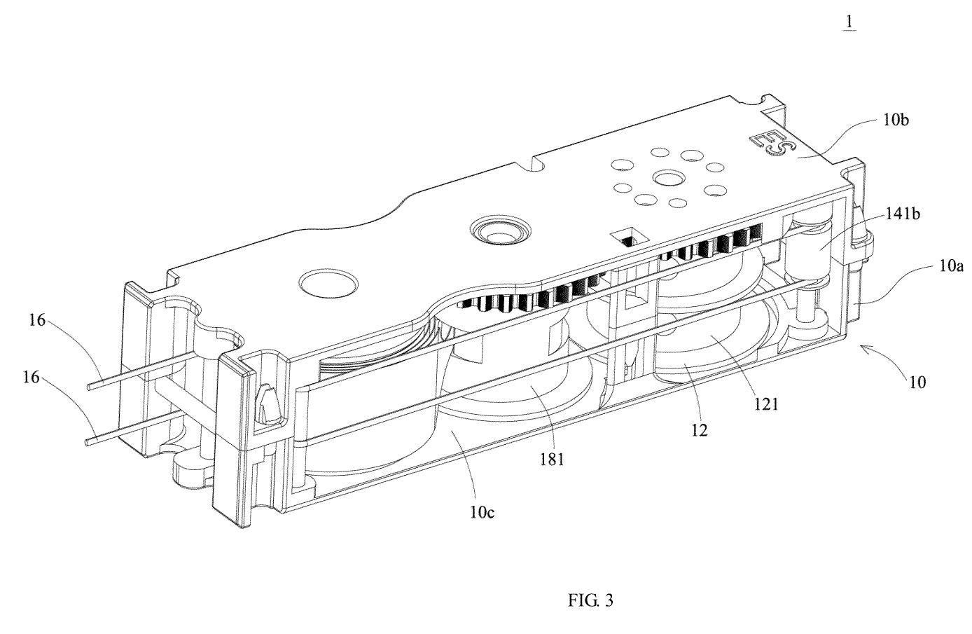

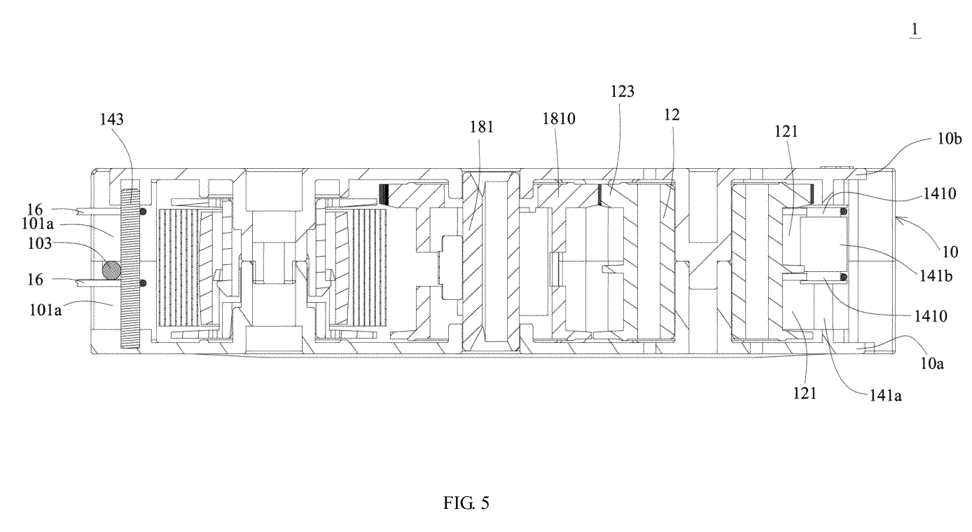

Referring to FIGS. 1-6, an embodiment of the present invention provides a carrying cord winding and unwinding device 1 of a curtain, including a base 10, a reel 12, a cord guide mechanism 14, and at least two carrying cords 16.

The base 10 defines a cord outlet 101 in a predetermined position.

The reel 12 is rotatably mounted to the base 10, and defines at least two wind slots 121 arranged side by side along an axial direction in an outer surface of the reel 12.

The cord guide mechanism 14 is set on the base 10, and arranged between the reel 12 and the cord outlet 101.

The at least two carrying cords 16 correspond one-to-one with the at least two wind slots 121. Corresponding ends of the carrying cords 16 are wound in the same direction in the corresponding wind slots 121, while the other ends are led out from the corresponding wind slots 121 and extended out from the cord outlet 101 under the guidance of the cord guide mechanism 14.

The cord guide mechanism 14 includes a synchronous guide component 141. The synchronous guide component 141 includes a core shaft 141a and a slide sleeve 141b.

The core shaft 141a is arranged parallel to the reel 12 and located on a side of the reel 12.

The slide sleeve 141b is axially slidably fitted about the core shaft 141a, and an outer side of the slide sleeve 141b defines at least two annular guide slots 1410 that correspond one-to-one with the at least two wind slots 121 and are arranged side by side in an axial direction. A bottom width of the annular guide slots 1410 is adapted to a diameter of the carrying cords 16, and a center distance of any two adjacent annular guide slots 1410 is the same as a distance between leading out positions of the carrying cords 16 in any two adjacent wind slots 121.

In the embodiment, the synchronous guide component 141 is added to the side of the reel 12, which includes the core shaft 141a and the slide sleeve 141b fitting about the core shaft 141a. The outer side of the slide sleeve 141b defines the annular guide slots 1410 that correspond one-to-one with the wind slots 121 and are arranged side by side in the axial direction for the carrying cords 16 being wound thereon correspondingly. The bottom width of the annular guide slots 1410 is designed to match the diameter of the carrying cords 16, which can effectively prevent the carrying cords 16 from sliding axially in the corresponding annular guide slots 1410 and only drive the slide sleeve 141b to slide axially. During the process of winding or unwinding the carrying cords 16, the carrying cords 16 are in the wind slots 121 to be wound or unwound along the axial direction of the reel 12, and drive the slide sleeve 141b to synchronously slide axially on the core shaft 141a. Moreover, with the design that the center distance between any two adjacent annular guide slots 1410 is the same as the distance between the lead out positions of the carrying cords 16 in any two adjacent wind slots 121, the winding or unwinding lengths of the carrying cords 16 are always consistent, ensuring that the curtain body connected to the other end of the carrying cords 16 can always be balanced and lifted without tilting.

In implementation, the number of the wind slots 121 on the reel 12 can be 2, 3, or even more, and a corresponding number of the carrying cords 16 can be assembled to adapt to curtains of different widths. In the embodiment, as shown in FIGS. 1-6, there are two wind slots 121 on the reel 12, corresponding to the two carrying cords 16.

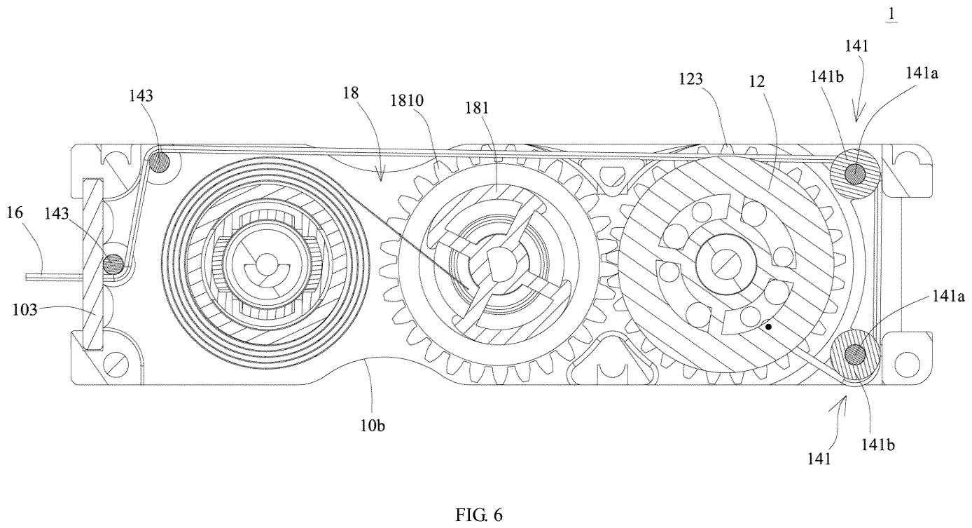

In an embodiment, as shown in FIGS. 1 and 6, at least two synchronous guide components 141 are arranged in parallel at corresponding corners of the base 10. The carrying cords 16 led out by the reel 12 sequentially extend about the corresponding synchronous guide components 141 and then extend in the direction of the cord outlet 101. The reel 12 is arranged at one end of the base 10 and is located on an inner side of movement paths of the carrying cords 16 between the synchronous guide components 141. In the embodiment, the synchronous guide components 141 are respectively arranged at the corresponding corners of the base 10, which can effectively maintain the distance between adjacent carrying cords 16 unchanged throughout the movement paths of the carrying cords 16, and is conducive to maintaining the consistent length of the carrying cords 16.

In an embodiment, as shown in FIGS. 1-3 and 6, the cord guide mechanism 14 further includes a plurality of guide rods 143 arranged between the synchronous guide component 141 and the cord outlet 101 and arranged in sequence along the movement paths of the carrying cords 16, and each guide rod 13 has a smooth outer surface. The carrying cords 16 extend from the synchronous guide component 141, extend about the outer surfaces of the guide rods 143, and then extend out through the cord outlet 101. The embodiment sets the plurality of guide rods 143 with smooth outer surfaces between the synchronous guide component 141 and the cord outlet 101, and gradually guides the movement paths of the carrying cords 16 using the guide rods 143 to avoid interference between the carrying cords 16 and other structures of the base 10 during the movement process.

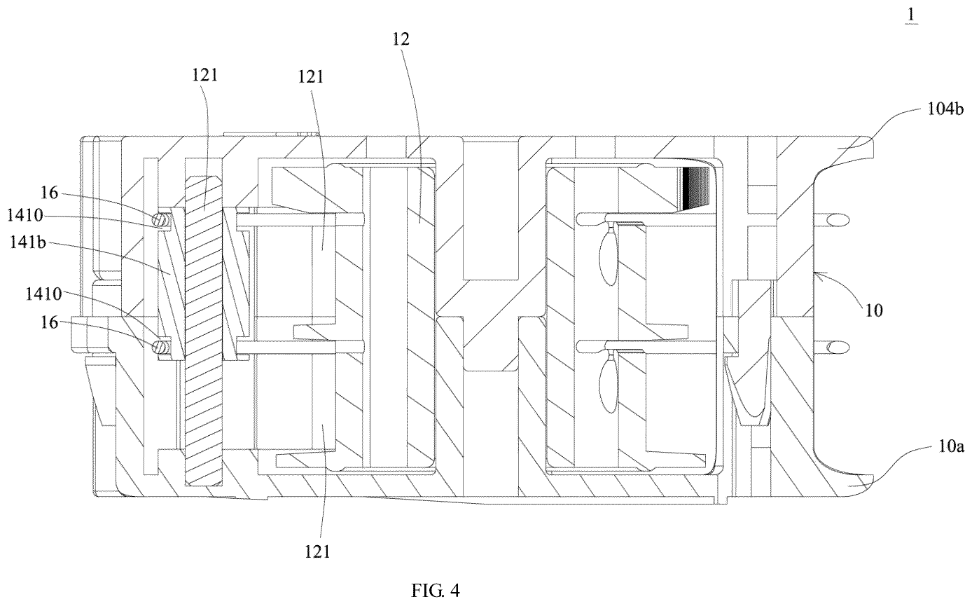

In an embodiment, a cross-section of each annular guide slot 1410 is V-shaped or U-shaped, which is U-shaped in FIG. 4. In the embodiment, the cross-section of the annular guide slot 1410 can be designed in a V-shape or U-shape, which can effectively locate the corresponding carrying cord 16 and prevent axial sliding and detachment of the carrying cord 16 in the annular guide slot 1410.

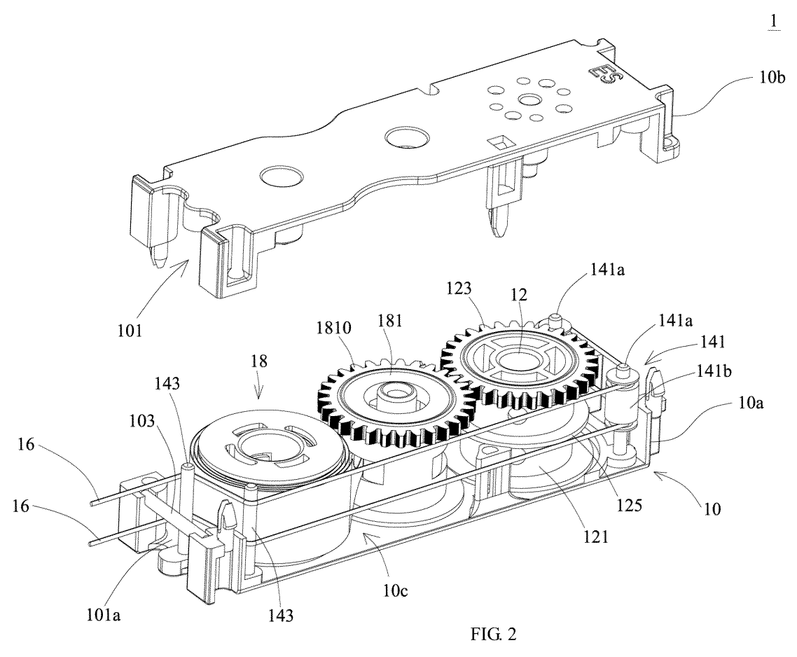

In an embodiment, as shown in FIGS. 2, 5, and 6, the cord outlet 101 is located at one end of the base 10 away from the reel 12. One said guide rod 143 is provided on an inner side of the cord outlet 101, and a partition rod 103 is also assembled inside the cord outlet 10. The partition rod 103 divides the cord outlet 101 into several channels 101a in the axial direction of the guide rod 143, which are the same number as the number of the carrying cords 16. The carrying cords 16 extend out from the channels 101a in a one-to-one correspondence. In the embodiment, the guide rod 143 is installed on the inner side of the cord outlet 101 to facilitate the directional movement of the carrying cords 16. The partition rod 103 is also installed to divide the cord outlet 101 into multiple channels 101, making it convenient for the carrying cords 16 to extend out from different channels 101 and avoiding interference between the carrying cords 16 inside the cord outlet 101.

In an embodiment, each of the opposite ends of the base 10 defines one cord outlet 101. In the embodiment, the cord outlets 101 are defined in the both ends of the base 10, so that different carrying cords 16 can be respectively extended from the opposite ends of the base 10 and connected to a curtain body, and the carrying cord winding and unwinding device 1 can be easily assembled to a middle section of an upper beam of the curtain. Moreover, when necessary, all carrying cords 16 can also extend out from the cord outlet 101 at one end of the base 10, and the carrying cord winding and unwinding device 1 is usually set at one end of the upper beam. It can be seen that the embodiment enriches the installation positions of the carrying cord winding and unwinding device 1 on the upper beam, which can be flexibly selected and adjusted according to needs in practical applications.

In an embodiment, as shown in FIGS. 1-6, the base 10 includes a bottom shell 10a and a shell cover 10b that are interlocked to form an installation space 10c for accommodating the reel 12 and the cord guide mechanism 14. The cord outlet 101 is defined in the bottom shell 10a. In the embodiment, the base 10 is fastened by the bottom shell 10a and the shell cover 10b to form the corresponding installation space 10c for accommodating the reel 12 and the cord guide mechanism 14, which can effectively protect the internal structure and achieve a protective effect.

In an embodiment, as shown in FIGS. 1-6, the device further includes a planar spiral spring mechanism 18 assembled in the installation space 10c for driving the reel 12 to rotate to wind the carrying cord 16. An output shaft 181 of the planar spiral spring mechanism 18 is coaxially provided with a driving gear 1810, and the reel 12 is coaxially provided with a driven gear 123, which meshes with the driving gear 1810. The embodiment uses a common power mechanism, which is the planar scroll spring mechanism 18, to drive the reel 12. Specifically, the driving is achieved by the driving gear 1810 on the output shaft 181 of the planar scroll spring mechanism 18 meshing with the driven gear 123 on the reel 12. The structure is simple and the driving is smooth.

In an embodiment, as shown in FIGS. 1-5, each of the wind slots 121 is provided with a fixing hole 125 for fixing the end of the carrying cord 16. The fixing holes 125 located in the wind slots 121 are arranged in a straight line at equal intervals in the axial direction of the reel 12, and the hole spacing between any two adjacent fixing holes 125 is the same as the center distance between any two adjacent annular guide slots 1410. In the embodiment, the fixing holes 125 for fixing the ends of the carrying cords 16 set in the wind slots 121 are designed to be arranged in a straight line at equal intervals in the axial direction of the reel 12, and the hole spacing between any two adjacent fixing holes 125 is the same as the center distance of any two adjacent annular guide slots 1410, which enables the carrying cords 16 to be synchronously wound in the corresponding annular guide slots 1410, and ensures that the distance between the leading out positions of the carrying cords 16 in any two adjacent wind slots 121 is the same as the center distance of any two adjacent annular guide slots 1410, so that the lengths of the carrying cords 16 synchronously wound or unwound are always consistent.

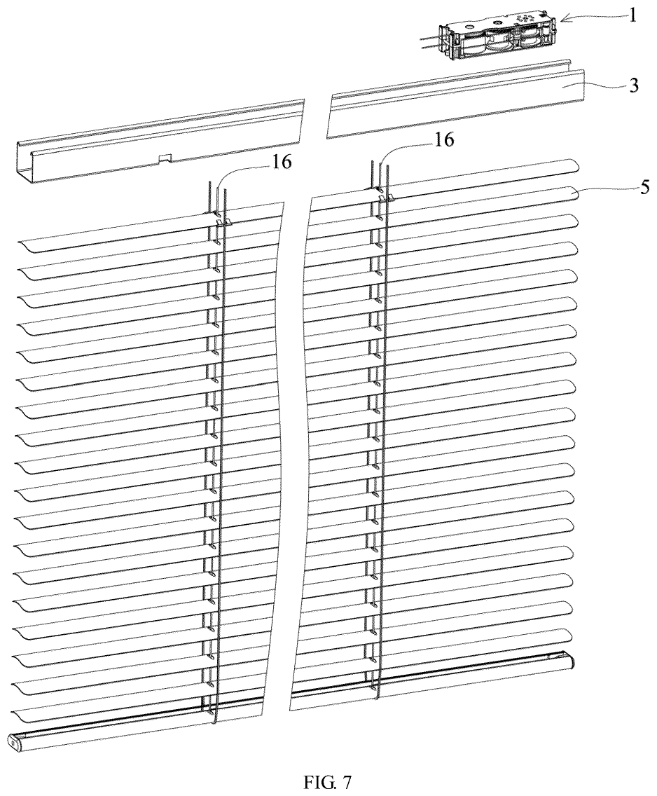

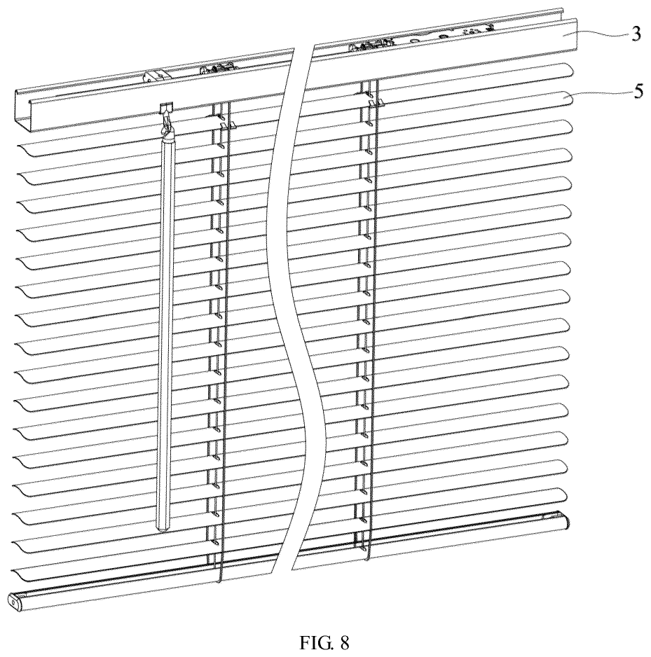

On the other hand, as shown in FIGS. 7-8, another embodiment of the present invention provides a curtain including an upper beam 3, a carrying cord winding and unwinding device 1 assembled on the upper beam 3, and a curtain body 5 arranged below the upper beam 3 and connected to a carrying cord 16 of the carrying cord winding and unwinding device 1, which rises correspondingly under the driving of the carrying cord winding and unwinding device 1. The carrying cord winding and unwinding device 1 is the carrying cord winding and unwinding device 1 described in any of the above-mentioned embodiments. The curtain provided in the embodiment can effectively achieve smooth lifting and lowering of both ends of the curtain body 5 by using the carrying cord winding and unwinding device 1 of any of the aforementioned embodiments. In the embodiment shown in FIGS. 7-8, the curtain is a louvered curtain. It can be understood that the curtain can also be a Roman curtain, a honeycomb curtain, or another curtain product that uses carrying cords to suspend and drive the curtain body 5 to rise and fall.

The embodiments of the present invention have been described above with reference to the accompanying drawings, but the present invention is not limited to the specific implementations described above, and the specific implementations described above are only schematic and not limiting. Under the enlightenment of this invention, many forms can be made without departing from the scope of this invention and the scope of protection of the claims, and these are all included in the scope of protection of this invention.

What is claimed is:

1. A carrying cord winding and unwinding device, comprising:
a base defining a cord outlet in a predetermined position;
a reel rotatably mounted to the base, and defining at least two wind slots arranged side by side along an axial direction in an outer surface of the reel;
a cord guide mechanism set on the base, and arranged between the reel and the cord outlet; and
at least two carrying cords corresponding one-to-one with the at least two wind slots, wherein corresponding ends of the at least two carrying cords are wound in a same direction in the at least two wind slots, respectively, while the other ends are respectively led out from the at least two wind slots and extended out from the cord outlet under the guidance of the cord guide mechanism;
wherein the cord guide mechanism comprises at least one synchronous guide component, each of the at least one synchronous guide component comprises:
a core shaft arranged parallel to the reel and located on a side of the reel; and
a slide sleeve axially slidably fitted about the core shaft, and an outer side of the slide sleeve defining at least two annular guide slots that correspond one-to-one with the at least two wind slots and are arranged side by side in an axial direction of the slide sleeve; wherein a bottom width of the at least two annular guide slots is adapted to a diameter of the at least two carrying cords, and a center distance of any two adjacent annular guide slots is the same as a distance between leading out positions of the carrying cords in any two adjacent wind slots.

2. The carrying cord winding and unwinding device of claim 1, wherein the at least one synchronous guide component comprises at least two synchronous guide components arranged in parallel at corresponding corners of the base, the at least two carrying cords led out by the reel sequentially extend about the at least two synchronous guide components and then extend in a direction of the cord outlet; the reel is arranged at one end of the base and is located on an inner side of movement paths of the at least two carrying cords between the at least two synchronous guide components.

3. The carrying cord winding and unwinding device of claim 2, wherein the cord guide mechanism further comprises a plurality of guide rods arranged between the at least two synchronous guide components and the cord outlet and arranged in sequence along the movement paths of the at least two carrying cords, and each of the plurality of guide rods has a smooth outer surface; the at least two carrying cords extend from the at least two synchronous guide components, extend about the outer surfaces of the plurality of guide rods, and then extend out through the cord outlet.

4. The carrying cord winding and unwinding device of claim 1, wherein a cross-section of each of the at least two annular guide slots is V-shaped or U-shaped.

5. The carrying cord winding and unwinding device of claim 3, wherein the cord outlet is located at one end of the base away from the reel, one of the plurality of guide rods is provided on an inner side of the cord outlet, and a partition rod is assembled inside the cord outlet; the partition rod divides the cord outlet into a plurality of channels in the axial direction of the plurality of guide rods, which are the same number as the number of the at least two carrying cords; the at least two carrying cords extend out from the plurality of channels in a one-to-one correspondence.

6. The carrying cord winding and unwinding device of claim 3, wherein each of opposite ends of the base defines one said cord outlet.

7. The carrying cord winding and unwinding device of claim 1, wherein the base comprises a bottom shell and a shell cover that are interlocked to form an installation space for accommodating the reel and the cord guide mechanism, the cord outlet is defined in the bottom shell.

8. The carrying cord winding and unwinding device of claim 7, further comprising a planar spiral spring mechanism assembled in the installation space for driving the reel to rotate to wind the at least two carrying cords, wherein an output shaft of the planar spiral spring mechanism is coaxially provided with a driving gear, and the reel is coaxially provided with a driven gear, which meshes with the driving gear.

9. The carrying cord winding and unwinding device of claim 1, wherein each of the at least two wind slots is provided with a fixing hole for fixing the end of a corresponding carrying cord, the fixing holes located in the at least two wind slots are arranged in a straight line at equal intervals in the axial direction of the reel, and a hole spacing between any two adjacent fixing holes is the same as the center distance between any two adjacent annular guide slots.

10. A curtain, comprising:
an upper beam;
a carrying cord winding and unwinding device assembled on the upper beam, wherein the ladder winding and unwinding device is the carrying cord winding and unwinding device of claim 1; and
a curtain body arranged below the upper beam and connected to the at least two carrying cords, which rises correspondingly under the driving of the carrying cord winding and unwinding device.

11. A curtain, comprising:
an upper beam;
a carrying cord winding and unwinding device assembled on the upper beam, wherein the ladder winding and unwinding device is the carrying cord winding and unwinding device of claim 2; and
a curtain body arranged below the upper beam and connected to the at least two carrying cords, which rises correspondingly under the driving of the carrying cord winding and unwinding device.
